(19) United States
(12) Patent Application Publication
(10) Pub. No.: US 2005/0279385 A1
(43) Pub. Date: Dec. 22, 2005

(54) APPARATUS AND METHOD FOR POSITIONING A VEHICLE IN THE WASH AREA OF A VEHICLE WASH SYSTEM

(75) Inventors: Richard M. GRIER, Ankeny, IA (US); Terrence J. SMITH, Des Moines, IA (US)

Correspondence Address: ZARLEY LAW FIRM P.L.C., CAPITAL SQUARE, 400 LOCUST, SUITE 200, DES MOINES, IA, 50309-2350, US

(73) Assignee: RYKO MANUFACTURING COMPANY, Grimes, IA (US)

(21) Appl. No.: 11/160,274

(22) Filed: Jun. 16, 2005

Related U.S. Application Data
(60) Provisional application No. 60/580,031, filed on Jun. 16, 2004.

(51) Int. Cl. B08B 7/04; B08B 3/00

(52) U.S. Cl. 134/18; 134/34; 134/123; 134/56 R

(57) ABSTRACT

A method and system for positioning a vehicle within the wash area of a wash system having a first sensor positioned near the entry of the wash system and a second sensor positioned near the exit of the wash system. A signal is operatively connected to the sensors to signal the driver to stop, back up, and confirm that the vehicle is located in the wash area between the first and second sensors.

### CROSS REFERENCE TO A RELATED APPLICATION

This application claims the benefit of Provisional Patent Application Ser. No. 60/580,031 filed Jun. 16, 2004.

### BACKGROUND OF THE INVENTION

The present invention is related to an apparatus and method for positioning a vehicle in the wash area of a vehicle wash system.

A variety of vehicle washing systems are known in the art including both friction and touch-free (i.e., automatic spray wash) types. Some wash systems use conveyors to move the vehicle through wash equipment, while others move over and around the vehicle once positioned in the wash area. This invention relates more to the latter.

In one group of prior art wash systems, one or more guide rails mounted on the floor were used to direct the driver to a position within the wash system such that one or both of the front tires were trapped within or made contact with one or more bay plates or treadles. The bay plates and treadles included or worked in conjunction with, in many cases, two sensors. The first sensor, such as a mercury switch or an inductive proximity sensor, detected the presence of the vehicle when the front tire contacted a portion of a bay plate or treadle causing the activation of a stop signal for the driver and the initiation of the wash system. The second sensor, such as an air switch with a hose on the floor or an inductive proximity sensor, was positioned further into the wash area (i.e., the desired area in which the vehicle is to be washed), for example, approximately one or two feet, to detect the presence of the vehicle after it had traveled too far into the wash area, and, when tripped, caused the activation of a back-up signal for the driver and suspended the wash cycle. Problems associated with those prior art approaches included the difficulty of precisely positioning the vehicle with respect to the first sensor, driving onto and off of a raised surface, and keeping the wash system in service due to mechanical failures inherent with such sensors. Also, the bay plates and treadles provided a limited area in which a driver would be signaled to stop and the vehicle would come to a halt without also tripping the second sensor. If the vehicle traveled too far and tripped the second sensor, the driver would be instructed to back up, which was time-consuming allowing for fewer washes in a given time period and frustrating drivers.

This process and its associated structure was improved upon, and the need for a bay plate or treadle eliminated, through the use of two non-contact sensors, e.g., photoelectric sensors, which signaled the driver as to whether the front of the vehicle was in the proper or improper position. An example of this improved process was disclosed at least as early as 1996 by the Atlantis Wash System produced by Ryko Manufacturing Co. The Atlantis as well as certain European wash systems have had two such sensors positioned forward of the vehicle near the exit end of the wash area. As the vehicle entered the wash area and the first sensor detected the front of the vehicle, the first sensor would, through a control device, activate a sign instructing the driver to stop. If the driver continued to advance within the wash area and the second sensor detected the front of the vehicle, then the second sensor would, through the control device, activate a sign instructing the driver to back up until the front of the vehicle was detected by the first sensor, but not the second sensor. While this improvement eliminated the need for bay plate(s) and treadle(s), a problem inherent with this approach was that it, like the bay plate and treadle approaches noted above, provided a limited amount of space between the two front sensors, usually two feet or less, for the vehicle to stop before triggering the second sensor. Also, this system did not verify that the back of the vehicle was sufficiently within the wash area to allow for washing.

Therefore, a need exists for a means of positioning a vehicle within a wash area that provides greater flexibility for the vehicle to stop once signaled, and preferably that ensures that the rear of the vehicle is sufficiently within the wash area.

### SUMMARY OF THE INVENTION

A method and system for positioning a vehicle within the wash area of a wash system having a first sensor positioned near the entry of the wash system and a second sensor positioned near the exit of the wash system. A signal is operatively connected to the sensors to signal the driver to stop, back up, and confirm that the vehicle is located in the wash area between the first and second sensors.

### BRIEF DESCRIPTION OF THE DRAWINGS

FIG. 1 is a perspective view of one embodiment of a vehicle wash system of the present invention.

FIG. 2 is a side view of the embodiment shown in FIG. 1.

FIG. 3 is a top plan view of an alternative embodiment of that shown in FIGS. 1 and 2.

FIG. 4 is a top plan view of an alternative embodiment of a vehicle wash system of the present invention.

FIG. 5 is a top plan view of an alternative embodiment of a vehicle wash system of the present invention.

### DETAILED DESCRIPTION OF PREFERRED EMBODIMENTS OF THE INVENTION

Referring to the drawings, embodiments of a vehicle wash system 10 include a track or rail structure 12 and a gantry 14 that includes a spray arm 16. These structures are known and can be made of a variety of materials, although portions can better resist corrosion with the use of stainless steel and a portion of the spray arm 16 can employ a polyethylene foam covering in case the spray arm 16 comes into contact with a protruding portion of the vehicle.

While the present wash system is described as a touch-free vehicle wash system, the invention can be used with other types of wash systems such as friction or combination wash systems.

The track structure 12 includes a pair of longitudinal tracks 18 in spaced parallel relation. The tracks 18 can be mounted to the floor or supported by a frame 20 that is mounted to the floor, side walls, or ceiling of a structure. Movably supported upon the tracks 18 is the gantry 14. The gantry 14, may in one embodiment only have a horizontal portion 22 that extends above a vehicle or may in other embodiments also have, for example, one or more vertical side portions (not shown). The gantry 14 can house, connect to, and/or include mechanical features of the wash system, and can provide surface area for instructive and advertising indicia.

The spray arm 16 is an inverted, generally L-shaped component that is rotatable about a central axis and movable along the length of the horizontal portion 22 of the gantry 14. This movement allows the spray arm 16 to move across the width of the wash system 10. The spray arm 16 includes a plurality of spray nozzles 24 positioned to wash both the top and the sides of a vehicle.

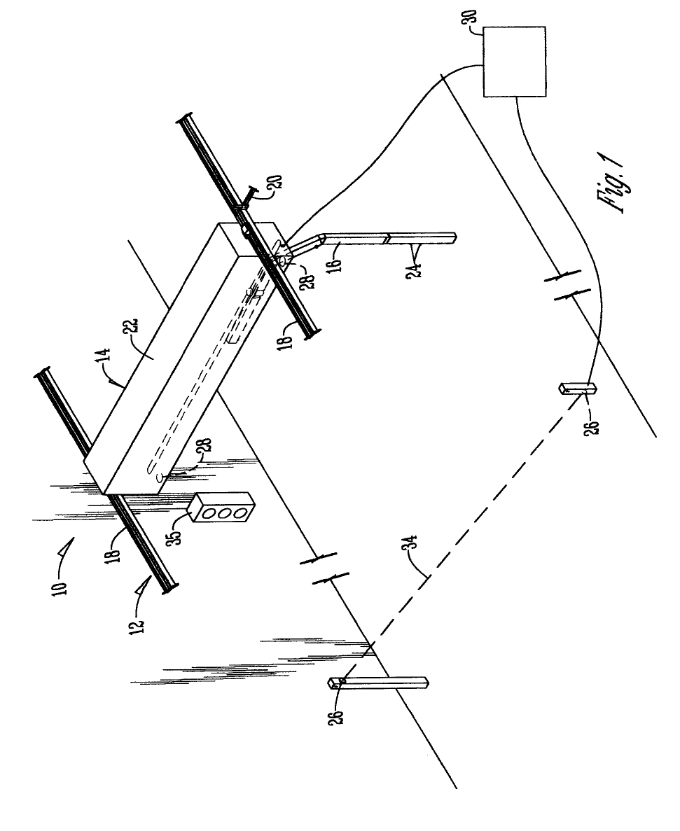

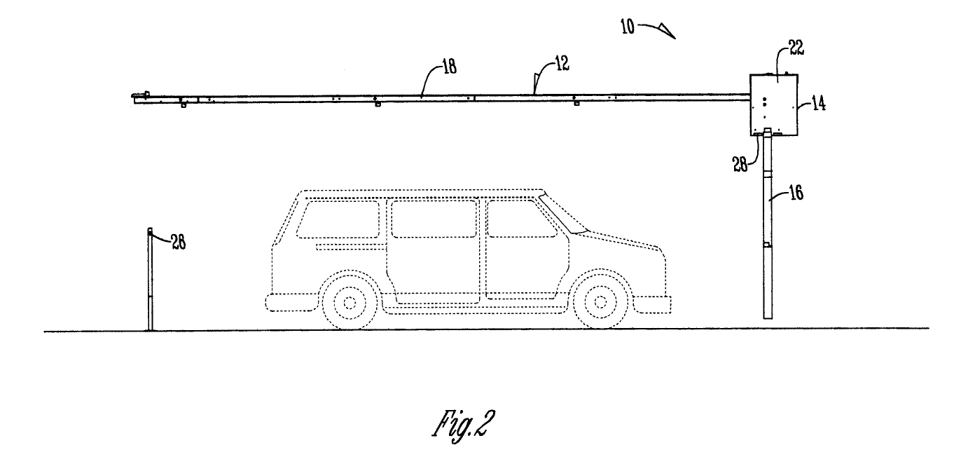

Positioned at or near the entrance of the wash area is a first sensor 26. The first sensor 26 can be mounted to support members connected to the floor, as shown in FIGS. 1 and 2, to the side walls of a structure, to another structure, or directly to the floor. While different types of sensors can be used, one embodiment is a photoelectric sensor (e.g., a Type MOFT transmitter, a Type MOFR receiver, and a Type S1420 amplifier, each available from Carlo Gavazzi Automation SpA) that generates a through-beam transmitted across the width of the vehicle wash area. In other embodiments, other sensors such as ultrasonic sensors can be employed, such as a US-25 Series, also known as an IRU-2000 Series, transducer from Scientific Technologies, Inc. Preferably, the first sensor 26 is aimed such that a beam (or, e.g., sound wave) travels generally diagonally across the entrance rather than horizontally to more similarly sense vehicles of different shapes and heights.

Positioned toward the exit of the wash area is a second sensor 28. While the second sensor 28 can be mounted in similar fashion as the first sensor 26, it is preferred that the second sensor 28 be mounted to the gantry 14 when the gantry 14 is parked at or near the exit of the wash area when not washing a vehicle.

The second sensor 28 can be of different types, such as an ultrasonic sensor, e.g., US-25 Series, also known as an IRU-2000 Series, transmitter and US-25 Series receiver available from Scientific Technologies, Inc. or it can be the same as sensor 26. The second sensor 28 can have a first portion mounted at or near one end of the horizontal portion 22 of the gantry 14 that transmits a sound wave that bounces off an object such as the floor of the wash area or the top of the vehicle. A second portion of the ultrasonic second sensor 28 is positioned at or near the other end of the horizontal portion 22 of the gantry 14 as shown in FIGS. 1 and 2 and receives the reflected sound wave.

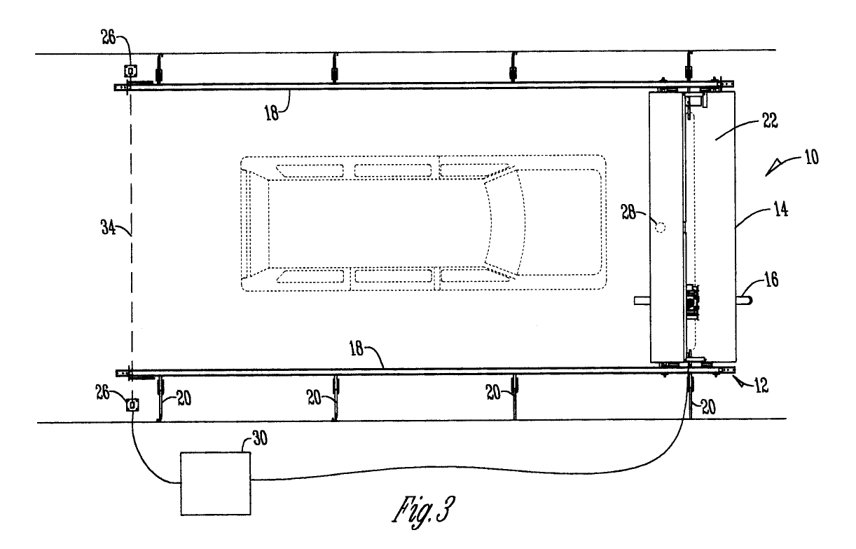

Another approach is the use of an ultrasonic sensor 28 mounted on the horizontal portion 22 of the gantry 14, as shown in FIG. 3, that both transmits and receives a vertical sound wave.

Returning specifically to the approach shown in FIG. 1 (although the following applies to other approaches), both the first sensor 26 and the second sensor 28 are connected (by wire or by wireless signal transmission) to a control device 30. The control device 30 is similarly connected to and controls the remainder of the wash system 10, which includes signaling a driver of the vehicle either audibly, visually, or by both means, based on the detected presence of the vehicle, as will be described further. The control device 30 can, for example, be a programmable logic controller, such as model FX2n, manufactured by Mitsubishi Electric Corporation. The second sensor 28 can also be used to locate what is deemed by the control device 30 to be the furthest forward (or representative) portion of the front and a furthest rearward (or representative) portion of the rear of the vehicle, e.g., the front and rear bumpers on some vehicles. The control device 30 can thereby position the spray arm 16 relative to those portions of the vehicle. (By saying “deemed by the control device . . . ,” applicants mean that the control device 30 controls the longitudinal movement of the gantry 14 through sensing intended to locate or approximate the location of the furthest forward and rearward portions of the vehicle or reference points on the vehicle's exterior.)

In operation, when the vehicle enters the wash area, the vehicle breaks the through beam 34 generated by the first sensor 26. As the vehicle continues to move through the wash area and past the first sensor 26, the through beam 34 will be restored and the control device 30 will indicate to the driver either audibly or visually by a sign 35, or by both means, instructing the driver to stop. (Sign 35 is shown as a simple three-light sign, although it could be more sophisticated such as being programmable to show, for example, text messages at various times or in various situations.) If desired, the signal to the driver can be initiated in a time-delayed interval after the through beam 34 is restored and no longer senses the presence of the vehicle.

If the driver continues through the wash area such that the second sensor 28 detects the presence of the vehicle, the control device will indicate to the driver either audibly, visually, or by both means, that the vehicle has traveled too far within the wash area and request that the vehicle be backed up so that neither the first sensor 26 nor the second sensor 28 detects the presence of the vehicle. The first sensor 26 and the second sensor 28 are spaced a sufficient distance to allow most vehicles to fit between while also allowing sufficient space for the vehicle to stop after clearing the first sensor 26. If the first sensor 26 and second sensor 28 detect the presence of the vehicle simultaneously, then the control device 30 determines that the vehicle is too long and will not operate and will inform the driver of this and to seek a refund.

Once the vehicle is positioned within the wash area such that neither the first sensor 26 nor the second sensor 28 detects the presence of the vehicle, the gantry 14 moves toward the vehicle until the second sensor 28 detects the presence of the vehicle and locates what is deemed by the control device 30 to be the furthest forward (or a representative) portion of the front of the vehicle. Once this furthest forward portion of the vehicle is deemed located, the control device can cause the next step in the process to occur.

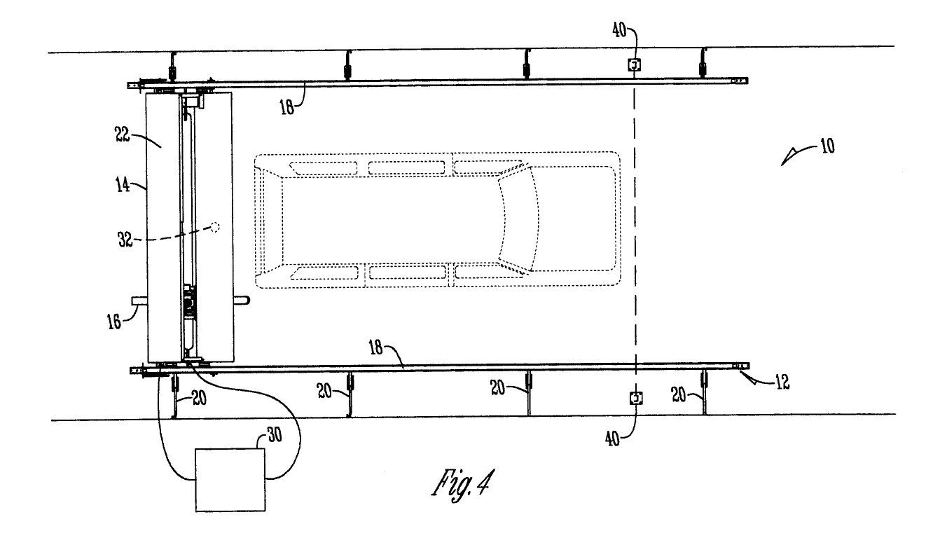

Another embodiment of the invention shown in FIG. 4 includes a sensor 38 mounted to the gantry 14 that, with the control device 30, directs the vehicle to the proper position within the wash area. The sensor 38 is preferably an ultrasonic sensor that sends and receives a sound wave in a vertical path. In this embodiment, the gantry 14 is initially parked at or near the entrance of the wash area. As the vehicle enters the wash area, the sensor 38 detects the presence of the vehicle.

Sensor 40 is positioned at or near the exit of the wash area and is mounted to a support member or a bay wall, ceiling, or floor. Sensor 40 works in conjunction with sensor 38 to direct the vehicle to the proper position relative to the entrance and exit of the wash area. After the vehicle passes sensor 38, which is at or near the entrance of the wash area, the driver is signaled to stop. If the vehicle travels too far, such that sensor 40 detects the presence of the vehicle, the driver will be instructed to back up. Or, if the vehicle does not clear sensor 38 before being detected by sensor 40, the control device 30 will deem the vehicle to be too long and instruct the driver to exit. This embodiment allows the wash cycle to begin from the rear of the vehicle, and includes the benefits of previous embodiments.

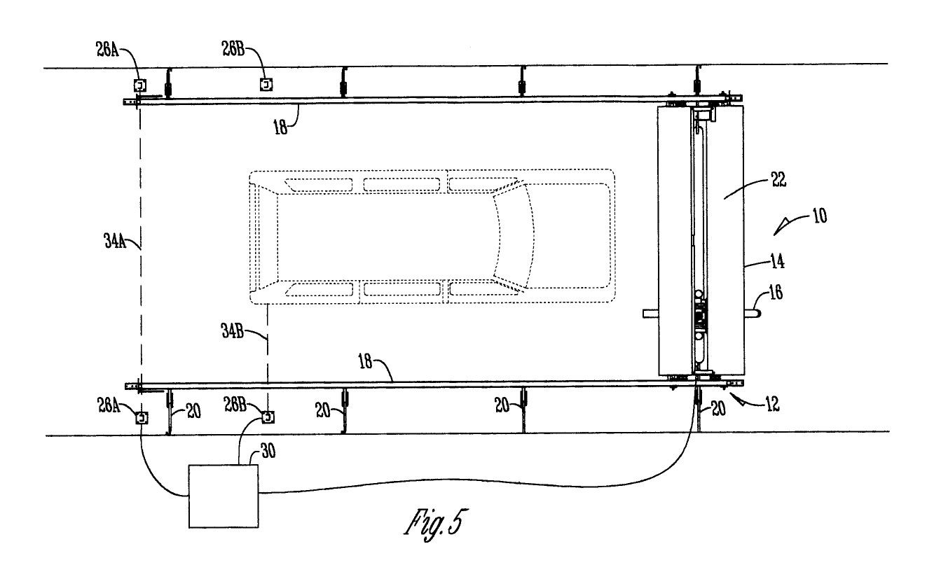

Still another embodiment is shown in FIG. 5, which includes two sensors 26A, 26B positioned at or near the entrance of the wash area. Sensors 26A, 26B are, for example, photoelectric sensors and can locate what the control device 30 deems to be the furthest rearward portion of the vehicle as the vehicle enters the wash area. Sensor 26A is positioned within or relative to the wash area such that when the through beam 34A created by sensor 26A is restored (i.e., the vehicle passes this sensor 26A), the control device 30 would instruct the driver to stop. If the vehicle were to continue further into the wash area such that the through-beam 34B of sensor 26B is restored, the control device 30 would instruct the driver to back up. Like embodiments noted above, the washing of the vehicle can be initiated by the control device, for example, a certain time interval (a) after the through beam 34A of sensor 26A is restored assuming the through beam 34B of sensor 26B is not restored during that time interval, or (b) after the through beam 34B of sensor 26B is rebroken (when the vehicle is backing up) assuming the through beam 34A of sensor 26A is not also rebroken during that time interval. This embodiment can provide the advantage of positioning vehicles of various sizes as close as desired to the entrance end of the wash bay, which may be desirable when a previously washed vehicle is being dried just ahead of the wash area. A variation on the embodiment shown in FIG. 5 and described above includes a third sensor (not shown) positioned at or near the exit end of the wash area. (It could be, for example, positioned where sensor 28 is positioned in FIG. 1 or 3 or where sensor 40 is positioned in FIG. 4). This exit sensor could be a photoelectric sensor, an ultrasonic sensor or another type of sensor intended to sense the furthest forward portion of the vehicle. One advantage of this variation is that this exit sensor provides the control device 30 with the ability to identify a vehicle that is too long for the wash system 10. That is, the exit sensor could be positioned such that when it and sensor 26A simultaneously detect the vehicle, the control device 30 deems the vehicle to be too long and informs the driver of this. Another advantage is that the exit sensor provides the system 10 with the ability to wash a vehicle that approaches but does not exceed the length limitation of the system 10. That is, when the exit sensor and sensor 26B simultaneously detect the vehicle and the exit sensor and sensor 26A do not simultaneously detect the vehicle, the control device 30 deems the vehicle to be of an acceptable length but positioned too far forward, and instructs the driver to back-up so that the exit sensor no longer detects the vehicle.

Another embodiment useful with one or more of the above noted embodiments involves the use of a sensor (not shown) positioned at or near the entrance of the wash area. This sensor is configured with the control device 30 to, in effect, turn on one or more of the previously mentioned sensors, such as sensors 26, 28. One example of this initiating sensor is an air hose on the floor or ground. When the vehicle enters the wash area, a front tire contacts the air hose, which causes the control device 30 to, for example, instruct photoelectric sensors at or near the entrance and exit ends of the wash to transmit their through beams. This initiating sensor provides the advantage of reducing the occurrence of false readings by the sensors that, with the control device 30, instruct the wash system 10 to begin. An air hose type sensor is available from World Magnetics.

As can be seen, the described invention addresses needs not addressed by prior art wash systems. One of ordinary skill in the art will understand that, in addition to the structure and approaches noted above, still other structure and approaches are within the contemplation of the inventors to address these needs.

For example, the wash system 10 could employ other steps or means for spraying or cleaning the vehicle, sensing the vehicle, positioning the vehicle, instructing or guiding the driver, or controlling the wash system. With respect to spraying, a plurality of pivoting, rotating, reciprocating, or otherwise moving spray members could replace or augment the inverted L-shaped spray arm 16. Or, a plurality of inverted L-shaped arms or similar arms could be used.

With respect to cleaning, brushes, cloths or other friction members or means could replace or augment the spraying means. With respect to sensing, other sensors known in the industry could be used, including inductive sensors, magnetic or Hall Effect sensors, laser beam or other higher intensity beam sensors, and even contact sensors. With respect to instructing or guiding, raised or lowered portions of the floor or structures mounted to the floor such as stainless bars painted optic yellow could be used to provide a visual and/or tactile guide. With respect to controlling, the PLC could be replaced, for example, with a personal computer, a microprocessor-based proprietary controller, or even a relay-based logic device.

Still other embodiments of structure, methodology, and function and variations on embodiments described above are foreseeable by the applicants. This includes aspects described within web site www.ryko.com, which are hereby incorporated by reference.

In the foregoing portion of the description, sensors are referred to as detecting or sensing the vehicle or portions of the vehicle in certain situations, and are also referred to in certain other situations as not or no longer detecting or sensing the vehicle or portions of it. It is notable that these sensors can be and often are programmed to detect, sense, or send signals to other devices in desired ways. For example, a photoelectric sensor can be programmed, e.g., it can contain or be used in conjunction with software (or firmware, etc.), such that the sensor will send a signal to a control device if the sensor's beam is broken for any period of time, or such that the sensor sends the signal only if the beam is broken, for example, for at least 0.25 second. The control device can be programmed, in essence, to interpret this signal as an indication that a vehicle is present within a particular portion of the wash area. Or, the control device or an intermediate device between the sensor and the control device, can be programmed to, in essence, disregard or take no action based on a signal that corresponds to the beam being broken for less than a certain duration, e.g., 0.25 second. One reason for this is that a control device can recognize or interpret, then disregard a number of false positive indications regarding the presence of a vehicle because beams can be broken briefly, for example, by a bird flying by.

An ultrasonic sensor can be programmed similarly or work in conjunction with the similar programming of other devices. And, because an ultrasonic sensor uses a different sensing technique than a photoelectric sensor, it can be programmed in still different ways or work in conjunction with different programming of other devices. For example, when a vehicle is struck by waves from an ultrasonic sensor such that one wave bounces back to the sensor (or bounces to a receiving portion of the sensor), the sensor may have been programmed to send a signal to the control device that is intended to indicate the presence of the vehicle. Again, the control device or an intermediate device could instead be programmed such that some number or percentage of waves must be received by the sensor before a subsequent action is taken by the control device. Again, one reason for this is to recognize or interpret, then disregard false positives.

As a result of the variations that can be created with the use of programming of sensors or associated devices, including the use of timing or counts, or the use of similar techniques, the terms “detect,” “detecting,” “sense,” “sensing,” and other forms of these words are intended for the purposes of the foregoing description to apply to each of these variations or combinations of the variations. For example, for purposes of the foregoing description, a sensor can be considered to be detecting or sensing a vehicle when it detects or senses the slightest change, such as a beam breakage for 0.1 second, even if the sensor has been programmed not to send a signal to the control device or the control device is programmed to not take action as a result of a breakage of this short duration. But also for purposes of the foregoing description, a sensor can be considered to be detecting or sensing a vehicle only when the sensor sends a signal to, for example, a control device to indicate the presence of the vehicle; that is, in this usage, the sensor is not considered to be detecting or sensing a vehicle when it detects or senses a change, such as a beam breakage for 0.1 second, that is insufficient (due, e.g., to programming) for the sensor to send that signal to the control device.

1. A method of washing the exterior of vehicle positioned within a wash system having an entry end and an exit end, comprising the steps of:
locating a first sensor adjacent the entry end to sense the presence of a moving vehicle entering the wash system,
locating a second sensor adjacent the exit end to sense the presence of the vehicle,
providing a stop signal operatively connected to the first sensor to signal a driver of the vehicle to stop when the rear end of the vehicle clears the first sensor, and
washing the exterior of the vehicle while the vehicle is positioned within the wash system between the first and second sensors.

2. The method of claim 1 further comprising the step of providing a signal operatively connected to the second sensor to signal the driver of the vehicle to back up when the second sensor senses the presence of the vehicle.

3. The method of claim 1 wherein the driver is signaled to stop at a predetermined time after the rear of the vehicle passes the first sensor.

4. The method of claim 2 wherein the first and second sensors are operatively connected to the vehicle washing system to transfer data to the system to confirm the vehicle is located in the wash system between the first and second sensors.

5. The method of claim 1 comprising the further step of determining that the vehicle is too long for the wash system when both the first sensor and the second sensor simultaneously detect the presence of the vehicle.

6. The method of claim 1 further comprising the step of determining the front and the rear positions of the vehicle with the second sensor after the vehicle has stopped between the first and second sensors.

7. A vehicle wash system for positioning a vehicle within a wash area having an entry end and an exit end comprising:
a first sensor positioned adjacent the entry end of the wash area to sense the presence of a moving vehicle entering the wash area; and
a signal operatively connected to the first sensor to signal a driver of the vehicle to stop when the rear end of the vehicle clears the first sensor.

8. The device of claim 7 further comprising a second sensor positioned adjacent the exit end of the wash area and operatively connected to the signal to indicate to the driver of the vehicle to back up when the second sensor senses the presence of the vehicle.

9. The device of claim 7 wherein the driver is signaled to stop at a predetermined time after the rear of the vehicle passes the first sensor.

10. The device of claim 8, wherein the first and second sensors are operatively connected to the vehicle wash system to transfer data to the system to confirm the vehicle is located in the wash area between the first and second sensors.

11. The device of claim 10, wherein data is transferred from the first and second sensors to the wash system to determine that the vehicle is too long when both the first sensor and the second sensor simultaneously detect the presence of the vehicle.

12. The device of claim 8 wherein the second sensor is positioned on the wash system and determines the front and rear positions of the vehicle after the vehicle has stopped between the first and second sensors.

13. A vehicle wash system for positioning a vehicle within a wash area having an entry end and an exit end comprising:
a first and a second sensor positioned adjacent the entry end of the wash area in spaced relation that senses the presence of a moving vehicle entering the wash area; and
a signal operatively connected to the first sensor to signal a driver of the vehicle to stop when the rear end of the vehicle clears the first sensor.

14. The device of claim 13 wherein the signal is operatively connected to the second sensor to indicate to the driver of the vehicle to back up when a beam from the second sensor is restored.

15. The device of claim 13 wherein the driver is signaled to stop at a predetermined time after the rear of the vehicle passes the first sensor.
